(19) United States
(12) Patent Application Publication
(10) Pub. No.: US 2009/0277560 A1
(43) Pub. Date: Nov. 12, 2009

(54) CARRIER FOR COLD SEAL COATED FACE AND BACK

(75) Inventors: Dieter Urban, Speyer (DE); Jose Maria Torres llosa, Ludwigshafen (DE); Dirk Wulff, Schifferstadt (DE); Axel Weiss, Speyer (DE); Christofer Arisandy, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/297,277

(22) PCT Filed: May 2, 2007
(86) PCT No.: PCT/EP07/54249

§ 371 Date: Oct. 15, 2008

(30) Foreign Application Priority Data
May 2, 2006 (EP) 06113375.7

(51) Int. Cl. C09J 5/00; B32B 7/04

(52) U.S. Cl. 156/60; 428/352; 428/220

(57) ABSTRACT

A double-sidedly coated backing comprising on one side (referred to below as face) an outer layer of a pressure-sensitive adhesive and on the other side (referred to below as reverse) an outer layer of an apolar release coating forming a contact angle of greater than 85° with water at 20° C.

The invention relates to a double-sidedly coated backing comprising on one side (referred to below as face) an outer layer of a pressure-sensitive adhesive and on the other side (referred to below as reverse) an outer layer of an apolar release coating forming a contact angle of greater than 85° with water at 20° C.

Packaging is frequently produced by cold sealing double-sidedly coated backings. Backings of this kind have been coated on one side (referred to below as face) with an adhesive suitable for cold sealing. Prior to their use, the backings have generally been wound up to form a roll. In the course of such an operation, of course, the adhesive-coated face comes into contact with the reverse of the backing. So that the adhesive does not stick to the reverse (which would make the entire roll unusable), the reverse of the backing is coated with a release layer.

The adhesive and the release layer are selected so as not to stick to one another.

In general the adhesive used is a natural rubber and the release layer used is a polyamide, for example. The natural rubber, which is apolar, sticks hardly or not at all to the polyamide, which is polar.

The desire is for backings which are suitable for producing packaging by cold sealing but for which adhesives other than natural rubbers can also be used. The backings ought to have good performance properties, in particular a high sealing seam strength and good blocking resistance with respect to the release coating.

It was an object of the present invention to provide such backings.

Found accordingly have been the backing defined at the outset and its use.

The pressure-sensitive adhesive coating

The backing has on one side (face) an outer layer of a pressure-sensitive adhesive (PSA).

The coating with the PSA refers to a coating which is permanently tacky at room temperature (20° C.).

The PSA ought preferably to have effective adhesion (tackiness) in association with effective cohesion (internal strength within the adhesive layer).

The PSA therefore has at 20° C. preferably a peel strength (as a measure of the adhesion) of at least 1 N/2.5 cm in accordance with the measurement method below. Preferably the peel strength is 1 to 30, more preferably 5 to 25, very preferably 10 to 20 N/2.5 cm.

The shear strength, as a measure of the cohesion, is preferably greater than 10 minutes in accordance with the measurement method below. Preferably the shear strength is 10 to 3000 minutes, more preferably 100 to 2500 minutes, very preferably 500 to 2000 minutes.

### The Test Methods

The PSA is coated at 20 g/m2 (solids) onto polyethylene film and dried at 90° C. for 3 minutes.

For the determination of the peel strength (adhesion) a 2.5 cm wide test strip was bonded to a chromium-plated V2A stainless steel test plate and rolled on once using a roller weighing 1 kg. It is then clamped by one end into the upper jaws of a stress/strain testing apparatus. The adhesive strip is pulled from the test surface (V2A stainless steel) at 300 mm/min and at an angle of 180°, i.e. the adhesive strip was bent over and pulled off parallel to the test plate, and the force required to accomplish this was measured. The measure of the peel strength is the force, in N/2 cm, which resulted as the average value from five measurements (corresponding to AFERA standard method). The peel strength was determined 24 hours after bonding.

For the determination of the shear strength the test strips are bonded with an adhered area of 25 mm2 onto a chromium-plated V2A stainless steel test plate, rolled on once with a roller weighing 1 kg, stored for 10 minutes (under standard conditions, 1 bar, 21° C.) and then loaded in suspension with a 1.5 kg weight (under standard conditions, 1 bar, 21° C.). The measure of the shear strength was the time taken for the weight to fall off, in minutes; in each case the average was calculated from 5 measurements (corresponding to PSTC standard method).

The PSA comprises preferably a synthetic polymeric binder (PSA polymer) and, if appropriate, further additives.

The PSA polymer is obtainable preferably by free-radical addition polymerization of monomers.

With preference more than 50% by weight of these monomers are what are called principal monomers selected from C1 to C20 alkyl (meth)acrylates, vinyl esters of carboxylic acids comprising up to 20 C atoms, ethylenically unsaturated nitriles, vinyl halides, vinyl ethers of alcohols comprising 1 to 10 C atoms, or mixtures of these monomers.

The polymer is composed preferably of at least 50%, more preferably at least 70%, very preferably at least 85% by weight of what are called principal monomers.

With particular preference the PSA polymer is composed of more than 50%, in particular more than 70%, and very preferably more than 85% by weight of C1 to C20 alkyl (meth)acrylates, especially C2 to C10 alkyl (meth)acrylates.

Those which are to be mentioned include, for example, (meth)acrylic acid alkyl esters having a C1-C10 alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Vinyl esters of carboxylic acids having 1 to 20 C atoms are, for example, vinyl laurate, vinyl stearate, vinyl propionate, and vinyl acetate.

The vinyl halides are chlorine-, fluorine- or bromine-substituted ethylenically unsaturated compounds, preferably vinyl chloride and vinylidene chloride.

Examples of vinyl ethers include vinyl methyl ether and vinyl isobutyl ether. Preference is given to vinyl ethers of alcohols comprising 1 to 4 C atoms.

Examples of nitriles are acrylonitrile and methacrylonitrile.

Very particular preference is given to methyl acrylate, methyl methacrylate, ethyl acrylate, n-butyl acrylate, n-hexyl acrylate, octyl acrylate, and 2-ethylhexyl acrylate, and mixtures of these monomers.

Besides the principal monomers the PSA polymer may comprise further monomers as well. Mention may be made in particular of vinylaromatic compounds, such as styrene, vinyltoluene, a- and p-methylstyrene, a-butylstyrene, 4-n-butylstyrene, 4-n-decylstyrene, and hydrocarbons having 4 to 8 C atoms and one or two olefinic double bonds such as ethylene, butadiene, isoprene, and chloroprene.

Besides the principal monomers and further monomers the polymer may comprise auxiliary monomers containing functional groups, examples being monomers with carboxylic acid, sulfonic acid or phosphonic acid groups. Carboxylic acid groups are preferred. Examples that may be mentioned include acrylic acid, methacrylic acid, itaconic acid, maleic acid, and fumaric acid.

Examples of further auxiliary monomers include monomers comprising hydroxyl groups, especially C1-C10 hydroxyalkyl (meth)acrylates, (meth)acrylamide or phenyloxyethyl glycol mono(meth)acrylate, glycidyl acrylate, glycidyl methacrylate, and amino (meth)acrylates such as 2-aminoethyl (meth)acrylate.

With particular preference the PSA polymer comprises auxiliary monomers having a carboxylic acid group, especially acrylic acid; the amount is preferably 0.1 to 5% by weight, based on the polymer.

Also suitable are PSAs whose adhesive properties can be adjusted by photochemical crosslinking of the PSA polymer, as for example by irradiation with electron beams or UV light (acResin® from BASF)

The PSA polymer is photochemically crosslinkable if, for example, hydrogen protons can be extracted from the polymer's main chain photochemically, not least using a photoinitiator, or by means of electron beams, thus forming a free radical which is able to enter into further chemical reactions.

For this purpose the PSA may comprise a photoinitiator.

The photoinitiator may comprise, for example, what are called α-splitters, which are photoinitiators in which a chemical bond is cleaved to give rise to 2 free radicals which initiate the further crosslinking or polymerization reactions.

Examples that may be mentioned include acylphosphine oxides (Lucirin® products from BASF), hydroxyalkylphenones (e.g., Irgacure® 184), benzoin derivatives, benzyl derivatives, and dialkyloxyacetophenones.

In particular the compounds in question may be H-abstractors, which detach a hydrogen atom from the polymer chain; these are, for example, photoinitiators having a carbonyl group. This carbonyl group is inserted into a C—H bond to form a C—C—O—H moiety. Mention may be made here in particular of acetophenone, benzophenone and the derivatives thereof.

It is possible to use both classes of photoinitiators alone or else in a mixture. With preference the photoinitiators are H abstractors.

The photoinitiator, or at least one of the photoinitiators if a mixture is used, can be attached to the adhesive polymer.

With particular preference the photoinitiator in question is incorporated into the polymer chain by means of free-radical copolymerization. For this purpose the photoinitiator preferably comprises an acrylic or (meth)acrylic group.

Suitable copolymerizable photoinitiators are acetophenone derivatives or benzophenone derivatives which comprise at least one, preferably one, ethylenically unsaturated group. The ethylenically unsaturated group is preferably an acrylic or methacrylic group.

The ethylenically unsaturated group can be attached directly to the phenyl ring of the acetophenone or benzophenone derivative. In general there is a spacer group located between phenyl ring and ethylenically unsaturated group.

The spacer group may comprise up to 100 C atoms for example.

Suitable acetophenone derivatives or benzophenone derivatives are described in, for example, EP-A 346 734, EP-A 377 199 (1st claim), DE-A 40 37 079 (1st claim), and DE-A 38 44 444 (1st claim), and by means of this reference are also included in the disclosure content of the present specification. Preferred acetophenone derivatives and benzophenone derivatives are those of the formula

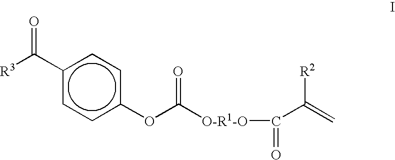

in which R¹ is an organic radical having up to 30 C atoms, R² is an H atom or a methyl group, and R³ is an optionally substituted phenyl group or a C1-C4-alkyl group.

R¹ is with particular preference an alkylene group, in particular a C2-C8 alkylene group.

R³ is with particular preference a methyl group or a phenyl group.

Suitable UV-crosslinkable PSAs comprise generally 0.0001 to 0.5 mol, more preferably 0.0002 to 0.1 mol, very preferably 0.003 to 0.01 mol of the photoinitiator, or of the molecular group which is attached to the polymer and is active as a photoinitiator, per 100 g of PSA polymer.

Suitable UV-crosslinkable polymers are available under the trade name acResin® from BASF.

The PSA used in accordance with the invention may be an aqueous PSA or a hot-melt adhesive, i.e., a substantially solvent-free and water-free PSA which is to be processed from the melt.

Preferably it is an aqueous PSA.

The aqueous PSA comprises the PSA polymer in particular in the form of an aqueous dispersion of the kind obtainable in particular by emulsion polymerization.

The glass transition temperature (Tg) of the PSA polymer is preferably −65 to +10° C., more preferably −65 to 0° C., very preferably −65 to −10° C., or −65 to −20° C.; in one very particularly preferred embodiment the glass transition temperature is −55 to −30° C., or −50 to −40° C.

The glass transition temperature of the polymer can be determined in accordance with customary methods such as differential thermoanalysis or differential scanning calorimetry (see, for example, ASTM 3418/82, midpoint temperature).

PSA polymers can be prepared by copolymerizing the monomers using the customary polymerization initiators and also, if appropriate, regulators, polymerization taking place at the customary temperatures in bulk (without solvent), in emulsion, such as in water or liquid hydrocarbons, or in solution. The polymerization, bulk polymerization for example, may also be carried out in an extruder. With particular preference the PSA polymer is prepared by emulsion polymerization.

The PSA may be composed of the binder (PSA polymer) alone or else may comprise further additives as well. Suitable examples include what are called tackifying resins (tackifiers).

Tackifiers are, for example, natural resins, such as rosins, and their derivatives formed by disproportionation or isomerization, polymerization, dimerization, and/or hydrogenation. These resins may be present in their salt form (with monovalent or polyvalent counterions (cations) for example) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Preferred tackifiers are natural or chemically modified rosins. Rosins are composed predominantly of abietic acid or abietic-acid derivatives.

Further adjuvants which may be added to the adhesive are, for example, antioxidants, fillers, dyes, and flow control agents.

The PSA and hence also the outer layer of the PSA is composed, apart from water or other solvents, in particular of more than 60%, more preferably of more than 70%, and very preferably of more than 80% by weight of the PSA polymer.

The thickness of the PSA layer can amount for example to from 1 μm to 3 mm, preferably 10 μm to 100 μm.

### The Release Coating

In accordance with the invention the backing has on the other side (reverse) an outer layer of an apolar release coating. One measure of the polarity of the surface is the contact angle formed by the edge of a drop of water with that on the substrate surface on which the drop is lying. In the case of a very polar surface the wetting is good; the drop lies flat on the surface and the angle between the edge and the surface is small. In the case of a very apolar surface the wetting is poor; the drop has more of a spherical shape and the contact area is smaller than the droplet diameter in the middle of the drop—in that case the angle is large.

The contact angle of a drop of water to the substrate surface at 20° C. is greater than 85° C., preferably greater than 90°, more preferably greater than 95°. The contact angle is determined by image analysis—that is, projection of the droplet contour onto a screen, and evaluation.

The release coating may be of any desired material; it may be a polymer film, which is laminated on or coextruded, or may be a liquid release varnish, which is applied and filmed.

In the case of a polymer film, suitable films are those of polyolefins, examples being polypropylene, oriented polypropylene or polyethylene. The polymer films are preferably not pretreated on the outer surface. In order that the desired contact angle comes about, no electrical discharge (corona pretreatment) should be carried out; moreover, the polymer films should not have been coated with polar primer either.

The release coating is preferably obtained by application of a liquid release varnish and subsequent drying.

The release varnish is preferably a dispersion or solution, the preferred solvent being water, water-miscible organic solvents or mixtures thereof. In particular the solvent is water or a mixture composed of at least 50%, in particular at least 75%, by weight of water.

The release varnish comprises in particular a synthetic apolar polymer (referred to below as release polymer for short).

The release polymer is preferably obtainable by free-radical additional polymerization of monomers. Preferably more than 60%, in particular more than 70%, more preferably more than 80%, and very preferably more than 90% by weight of the monomers are aliphatic hydrocarbons having 2 to 8 C atoms and one or two double bonds. With particular preference the monomers are aliphatic hydrocarbons having 2 to 8, more preferably 2 to 4, C atoms and one double bond. Very particular preference is given to ethylene.

Besides the apolar monomer, the release polymer may comprise further monomers as constituent components, and in particular these can also be monomers containing polar groups, examples being hydroxyl groups, amino groups, acid groups, ester groups or salt groups. Particular preference is given to monomers containing ester groups or acid groups, especially carboxylic acid groups. Particularly suitable monomers are monocarboxylic or dicarboxylic acids such as acrylic acid, methacrylic acid or maleic acid, and monomers comprising vinyl esters as ester groups, especially vinyl acetate.

The presence of polar groups, carboxylic acid groups for example, in the release polymer (preferably polyethylene) can alternatively be achieved by means of subsequent polymer-analogous reaction, an example being oxidation with oxygen.

The release polymer preferably has a polar groups content (see above), in particular an acid groups content, with particular preference a carboxylic acid groups content, of 0.01 to 1 mol per 100 g of release polymer; the amount is with particular preference at least 0.2 mol per 100 g of release polymer. The amount generally does not exceed 0.8 mol, or 0.6 mol, per 100 g of release polymer.

The release polymer preferably has a weight-average molecular weight Mw of 1000 to 100 00 g/mol, in particular 1000 to 40 000 g/mol, with particular preference of 1000 to 20 000 g/mol, with very particular preference of 3000 to 18 000 g/mol, and in one particular embodiment of 5000 to 15 000 g/mol (as determined by means of gel permeation chromatography).

The release varnish may comprise further constituents; those suitable include, in particular, emulsifiers and protective colloids for dispersing the release polymer in water.

Further adjuvants may be auxiliaries such as defoamers, auxiliaries for adjusting the pH (alkali metal hydroxide solutions, buffers) or dispersing assistants.

Processes for preparing release polymers are known. In the case of polyethylene, the customary catalytic polymerization processes are particularly suitable, after which the polymer obtained can be dissolved or dispersed in the selected solvent.

The release varnish can be applied in a conventional way. The application rate (without solvent or water, i.e., after drying) is for example 1 to 50 g/m², more preferably from 1 to 30 g/m², very preferably 1 to 10 g/m².

The dried layer of the release varnish is composed in particular of more than 60%, with particular preference more than 80%, with very particular preference more than 90%, by weight of the release polymer.

### The Backing Material

The backing itself may be composed for example of paper or a polymer film. The backing is composed in particular of a polymer film, metallized polymer film or corona-pretreated polymer film. Mention may be made in particular of films of oriented polypropylene, polyethylene, preferably high-density polyethylene, or polyesters, such as polyethylene terephthalate or polybutylene terephthalate.

### The Double-Sidedly Coated Backing in Total

The PSA coating can be coated directly on the face of the backing, although between the backing and the PSA coating there may also be other layers, such as primary layers or printing-ink layers (colored or black and white images). What is essential is that the layer of the PSA is located on the outside.

Between the release coating and the backing there may be further layers; those suitable include, in turn, layers of a primer which enhances the adhesion, and printing-ink layers. The outer release coating also has the function of protecting the underlying layers, particularly the printing-ink layer, with respect to external effects.

Preferred double-sidedly coated backings have the following construction, the sequence of the layers corresponding to the spatial arrangement:

PSA coating

### Backing

Primer layer if appropriate
Printing-ink layer if appropriate
Release coating

The double-sidedly coated backing preferably has a thickness totaling 1 μm to 2 mm, more preferably 1 μm to 200 μm.

### The Use

The double-sidedly coated backing of the invention is suitable in particular for cold sealing. By cold sealing is meant a method in which the temperature in the adhesive layer (and preferably also the temperature of the substrates to be bonded) is less than 40° C., in particular less than 30° C. or less than 25° C. In general cold sealing is carried out at the prevailing room temperature, in other words generally at temperatures from 10 to 30° C., in particular 15 to 25° C. The substrates are preferably contacted with exertion of pressure. Suitable pressures are those ranging from just a few millibar up to a number of bar above standard pressure (1 bar); mention may be made of pressures from 0.01 to 5 bar, in particular from 0.1 to 3 bar above standard pressure. The sealing time (time during which the temperature and, if appropriate, the pressure are maintained) is for example 0.1 to 20 seconds, in particular 0.1 to 3 seconds, with 0.5 second, in particular, being typical.

The backing of the invention is therefore suitable for joining two substrates, for which
at least one of the two substrates to be bonded is a double-sidedly coated backing of the invention and
the two substrates are contacted, with exertion of pressure if appropriate,
the temperature in the pressure-sensitive adhesive being less than 40° C. (cold sealing).

Preferably each of the two substrates to be bonded is a backing of the invention.

The double-sidedly coated backing is used in particular for producing packaging: for that purpose it can be bonded by cold sealing to any other substrates, especially polymer films (including, if appropriate, metallized or corona-pretreated polymer films).

The double-sidedly coated backing is preferably bonded to itself by cold sealing, the PSA-coated faces being brought into contact in each case.

The packaging is sealed by means of cold sealing as soon as the contents to be packaged have been introduced.

The packaging is particularly suitable for foods.

Substantial advantages of the backing of the invention are its good cold-sealability and good blocking resistance of the face on the reverse (the PSA layer does not adhere to the release layer). The backing can be rolled up and later processed from the roll. In the course of rolling, the face and the reverse of the backing come into direct contact. Sticking of the face to the reverse would make the backing unusable, and yet the backing of the invention can be processed without problems.

### EXAMPLES

### Production of the Double-Sidedly Coated Backing

The backing used is film of oriented polypropylene (oPP).

The film was coated on the reverse with a release varnish (0.07 mm wire doctor, 1.2 g/m2), and dried at 90° C. for 3 minutes.

The following release varnishes were used:
a polyamide solution (for comparison), contact angle of the surface with water: 85°
Poligen® WE1, a solution of a low molecular mass polyethylene with a low acrylic acid content (commercial product of BASF, in accordance with the invention); contact angle of the surface with water: 98°

The front face was coated with commercially customary aqueous PSA dispersions (0.1 mm wire doctor, for application rate see table) and dried at 105° C. for 30 seconds.

The pressure-sensitive adhesive dispersions used were as follows:

Acronal® V 212, a polyacrylate dispersion from BASF
Acronal® DS 3547, a polyacrylate dispersion from BASF

### Tests

### Sealing Seam Strength

Strips 15 mm wide were cut from the double-sidedly coated oPP films; two strips were placed with the adhesive side against one another and were sealed on the sealing apparatus at 2.1 bar for 0.5 second. Immediately after sealing, the peel strengths in N/15 mm were determined with a pull-off speed of 50 mm/min.

### Blocking Test

The double-sidedly coated oPP films were placed with the release varnish side against the PSA side and were subjected to a 10 metric ton weight load for 24 hours; thereafter the peel strength in N/25 mm was determined with a pull-off speed of 800 mm/min. As far as possible the adhesive side ought not to stick to the release varnish, and so the peel strength obtained should be as small as possible.

### Results

| PSA dispersion | Acronal V 212 | Acronal DS 3574 |
|---|---|---|
| Application rate of PSA in | 4.14 | 2.88 |
| g/m2 | | |
| Sealing seam strength (PSA | 1.45 | 1.46 |
| on PSA) | | |
| Blocking resistance | 0.3 | 0.45 |
| PSA on polyamide release | | |
| varnish | | |
| Blocking resistance | 0.11 | 0.07 |
| PSA on Poligen release | | |
| varnish | | |

1. A double-sided coated backing comprising on one side (referred to below as face) an outer layer of a pressure-sensitive adhesive and on the other side (referred to below as reverse) an outer layer of an apolar release coating forming a contact angle of greater than 85° with water at 20° C.

2. The double-sided coated backing according to claim 1, wherein the pressure-sensitive adhesive layer is composed of more than 60% by weight of a synthetic polymeric binder (referred to below as PSA (pressure-sensitive adhesive) polymer for short).

3. The double-sided coated backing according to claim 1, wherein the PSA polymer is obtainable by free-radical addition polymerization of monomers and more than 50% by weight of these monomers are what are called principal monomers selected from C1 to C20 alkyl (meth)acrylates, vinyl esters of carboxylic acids comprising up to 20 C atoms, ethylenically unsaturated nitrites, vinyl halides, vinyl ethers of alcohols comprising 1 to 10 C atoms, or mixtures of these monomers.

4. The double-sided coated backing according to claim 1, wherein the PSA polymer is composed of more than 50% by weight of C1 to C20 alkyl (meth)acrylates.

5. The double-sided coated backing according to claim 1, wherein the release coating is a release varnish which is applied in liquid form and then dried.

6. The double-sided coated backing according to claim 1, wherein the dried layer of the release varnish is composed of more than 60% by weight of a synthetic apolar polymer (referred to below as release polymer for short).

7. The double-sided coated backing according to claim 1, wherein the release polymer is obtainable by free-radical addition polymerization of monomers and more than 70% by weight of the monomers are aliphatic hydrocarbons having 2 to 8 C atoms and one or two double bonds.

8. The double-sided coated backing according to claim 1, wherein the release polymer is composed of more than 70% by weight of ethylene.

9. The double-sided coated backing according to claim 1, wherein the release polymer has a number-average molar weight of 1000 to 100 000 g/mol.

10. The double-sided coated backing according to claim 1, wherein the backing is paper or a polymer film.

11. The double-sided coated backing according to claim 1, wherein between the backing and the outer layer of the release varnish there may be further layers, such as a primer layer and/or a printing-ink layer.

12. The double-sided coated backing according to claim 1, having a thickness totaling 0.1 μm to 2 mm.

13. A method of joining two substrates, wherein
at least one of the two substrates to be bonded is a backing according to claim 1 and
the two substrates are contacted, with exertion of pressure if appropriate,
the temperature in the pressure-sensitive adhesive being less than 40° C. (cold sealing).

14. The method according to claim 13, wherein each of the substrates to be bonded is a backing according to claim 1.

15. The method of using the double-sided coated backing according to claim 1 for producing cold-sealable packaging.

16. The method of using the double-sided coated backing according to claim 1 for producing cold-sealable food packaging.
